(19) United States
(12) Patent Application Publication
(10) Pub. No.: US 2025/0040719 A1
(43) Pub. Date: Feb. 6, 2025

(54) ADJUSTABLE CAR SEAT CANOPY

(71) Applicant: Wonderland Switzerland AG, Steinhausen (CH)

(72) Inventors: Nathaniel W. KEEBLER, Perkiomenville, PA (US); Curtis M. HARTENSTINE, Birdsboro, PA (US)

(73) Assignee: Wonderland Switzerland AG, Steinhausen (CH)

(21) Appl. No.: 18/576,870

(22) PCT Filed: Jul. 12, 2022
(86) PCT No.: PCT/US2022/036774

§ 371 Date: Jan. 5, 2024

Related U.S. Application Data
(60) Provisional application No. 63/221,747, filed on Jul. 14, 2021.

(51) Int. Cl. A47C 7/66; B60N 2/26

(52) U.S. Cl. CPC A47C 7/66; B60N 2/26

(57) ABSTRACT

A height adjustable car seat canopy is disclosed herein that includes a canopy connected to at least one canopy mount. The at least one canopy mount is configured to slide up and down a canopy track protruding from the soft goods of the car seat. A height adjustable car seat headrest canopy assembly is also disclosed herein.

### CROSS REFERENCE TO RELATED APPLICATION

This application claims the benefit of U.S. Provisional Patent Application No. 63/221,747, filed on Jul. 14, 2021, which is incorporated by reference as if fully set forth.

### TECHNICAL FIELD

The present disclosure generally relates to a car seat canopy that shades a child in the car seat. More specifically, this disclosure relates to a car seat canopy that is configured to adjust to different positions by moving along a track protruding from the soft goods of a car seat.

### BACKGROUND

Convertible car seats, including 3-in-1 car seats, 4-in-1 car seats, and all-in-one car seats, can be adapted for use between different modes or positions as the child grows. Generally, convertible car seats can be used rear-facing so the child is facing the rear of the vehicle, then converted to forward-facing so the child is facing the front of the vehicle. Some convertible car seats also have a booster seat mode. The car seat can transition from rear-facing, to forward-facing, and then to booster seat to accommodate a growing child as well as satisfy height and weight safety standards. A convertible car seat may also have different recline and headrest positions to optimize the child's comfort.

Some car seats may also have a canopy to shade the child's face from sunlight that comes through the vehicle's window. However, depending on the position or mode of the car seat, the height of the child, and the angle of the sunlight, the child's face may still be exposed to the sunlight using a traditional car seat canopy. Therefore, a canopy configured to adjust to multiple positions is highly desirable.

### SUMMARY

The present disclosure is directed to an adjustable car seat canopy that transitions between a raised position and a lowered position to accommodate a growing child, changing positions of the sunlight, and different car seat modes.

In one aspect, a car seat canopy assembly is provided that includes at least one track, at least one canopy mount, and a canopy. The at least one track protrudes from a soft goods of a car seat. The at least one canopy mount is slidably connected to the at least one track such that the canopy mount can translate along the at least one track. The canopy is connected to the at least one canopy mount.

In another aspect, a car seat headrest canopy assembly is provided that includes at least one canopy mount and a canopy. The at least one canopy mount protrudes from a height adjustable headrest of a car seat. The canopy connects to the at least one canopy mount.

Additional embodiments are described below and in the claims.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1A is a side view of a car seat with a car seat canopy assembly in a raised position.

FIG. 1B is a side view of the car seat with the car seat canopy assembly in a lowered position.

FIG. 2 is an isometric view of the hard goods of the car seat.

FIG. 3 is a side view of the car seat and the hard goods of the car seat canopy assembly.

FIG. 4 is a side view of the car seat hard goods, a canopy track, a canopy mount, a first canopy bow connector, and a second canopy bow connector.

FIG. 5 is a side view of the canopy track, the canopy mount, the first canopy bow connector, and the second canopy bow connector.

FIG. 6A is an isometric view of the canopy mount in a raised position on the canopy track.

FIG. 6B is an isometric view of the canopy mount in a lowered position on the canopy track.

FIG. 7A is an isometric view of the canopy mount, the first canopy bow connector, and the second canopy bow connector.

FIG. 7B is an exploded view of FIG. 7A showing the first canopy bow connector and the second canopy bow connector disassociated from the canopy mount.

FIG. 8A is a side view of the canopy in a cocooning position.

FIG. 8B is a side view of the canopy in a stored position.

FIG. 9A is a side view of the canopy mount.

FIG. 9B is an isometric view of the canopy mount.

FIG. 10A is a side view of the canopy bow connector.

FIG. 10B is an isometric view of the canopy bow connector.

FIG. 11 is a side view of the canopy track.

FIG. 12 is a sectional view of another embodiment of the canopy track having a top plate with a track and a bottom plate fastened to the soft goods of the car seat.

FIG. 13A is a side view of the car seat and canopy mount according to another embodiment in which piping in the car seat soft goods with the car seat soft goods functions as the canopy track and the canopy mount is in the lowered position.

FIG. 13B is a side view of the hard goods of the canopy assembly of FIG. 13A with the canopy mount in the raised position.

FIG. 14 is a side view of a portion of the car seat and the canopy assembly depicted by section A in FIG. 13B with the first canopy bow connector removed.

FIG. 15 is a top view of a portion of the car seat and the canopy assembly of FIGS. 13A and 13B showing the piping in section.

FIG. 16A is a side view of a car seat with a height adjustable headrest and canopy assembly in the raised position.

FIG. 16B is a side view of the car seat with the height adjustable headrest and canopy assembly in the lowered position.

FIG. 17 is an isometric view of the height adjustable headrest and canopy mounts.

FIG. 18 is an isometric view of the height adjustable headrest with the canopy mounts shown exploded from the height adjustable headrest.

FIG. 19A is an isometric view of the outer side of the canopy mount for the height adjustable headrest.

FIG. 19B is another isometric view of the inner side of the canopy mount for the height adjustable headrest.

FIG. 20A is a side view of the car seat and the hard goods of the canopy assembly in a cocooning position.

FIG. 20B is a side view of the car seat and the hard goods of the canopy assembly in a stored position.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. A reference to a list of items that are cited as “at least one of a, b, or c” (where a, b, and c represent the items being listed) means any single one of the items a, b, or c, or combinations thereof. This terminology includes the words specifically noted above, derivatives thereof and words of similar import.

Convertible car seats, including 3-in-1 car seats, 4-in-1 car seats, and all-in-one car seats, can be used in two or more different modes including a rear-facing reclined infant mode, a front-facing harness mode, and a forward facing high-back booster mode. In each mode, it is common for a child to be exposed to direct sunlight through a window of the vehicle. An adjustable car seat canopy is provided that moves vertically up and down the car seat to accommodate a growing child. A headrest canopy is also provided that attaches to a height adjustable headrest of a car seat.

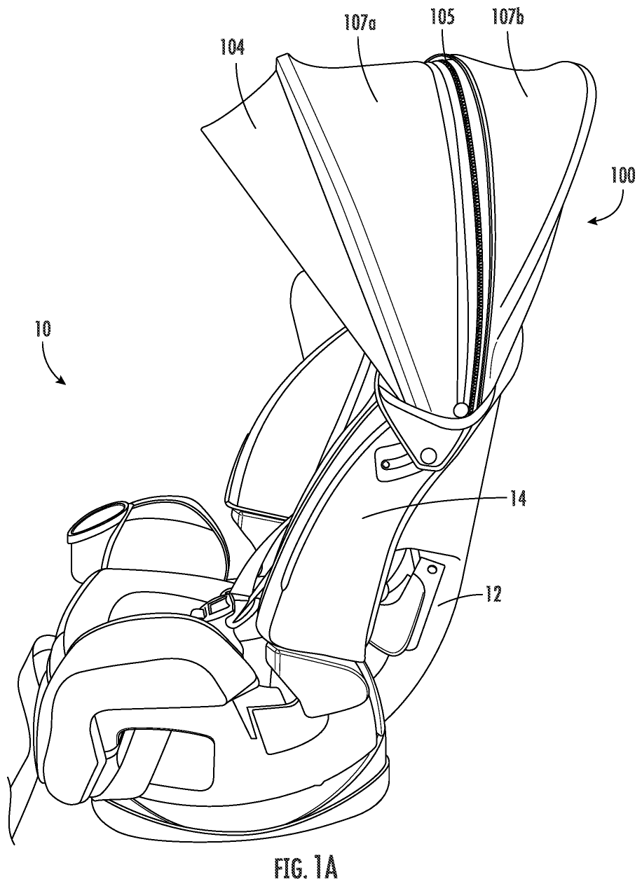

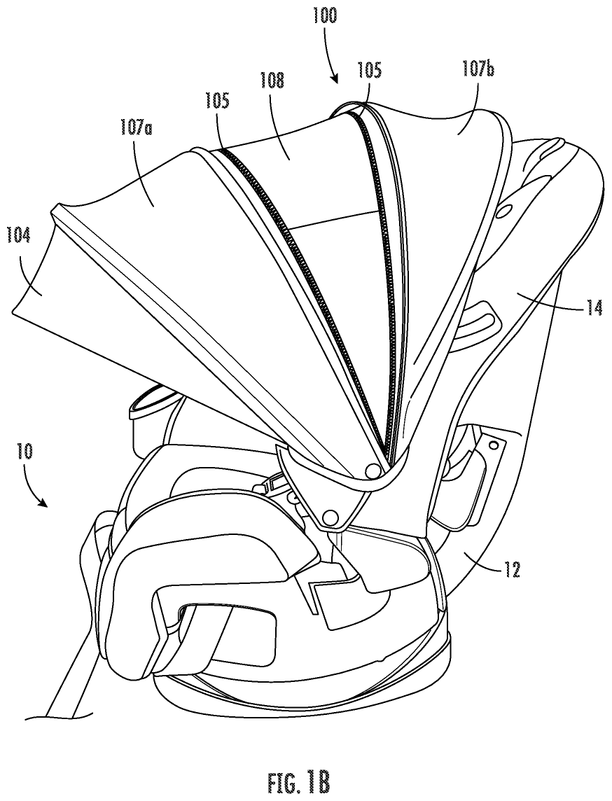

FIGS. 1A and 1B show a car seat 10 with a car seat canopy assembly 100. Without limitation, the car seat 10 may be a convertible car seat that transitions between a rear-facing mode, a forward-facing mode, and a high-back booster seat mode. The car seat 10 includes hard goods 12 and soft goods 14. The hard goods 12 include at least the frame 20 of the car seat 10. The soft goods 14 include at least the car seat 10 liner and padding. The soft goods 14 may be removably attached to the hard goods 12 of the car seat 10. The car seat canopy assembly 100 preferably includes a canopy 104. As shown in FIGS. 1A and 1B, the canopy 104 may include a zipper 105 along the seam of a first and second panel 107a, 107b. As shown in FIG. 1B, the zipper 105 can be unzipped to allow an otherwise collapsed and hidden panel 108 to expand to provide extra length to the canopy 104 to provide more shade to the child. Although a zipper 105 is shown in FIGS. 1A and 1B, one of skill in the art would understand that alternative fasteners may be used.

The car seat canopy assembly 100 can be configured so that the canopy 104 can move between a raised position, shown in FIG. 1A, and a lowered position, shown in FIG. 1B. As the child using the car seat 10 grows, the canopy 104 can be raised from a lowered position to a raised position. Similarly, the canopy 104 can be adjusted to a position that adequately shields the child from sunlight in the various car seat modes.

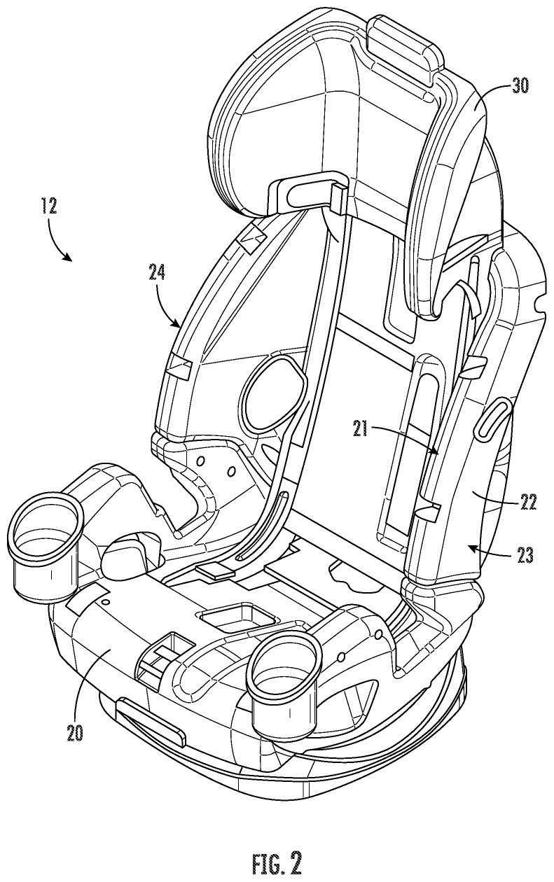

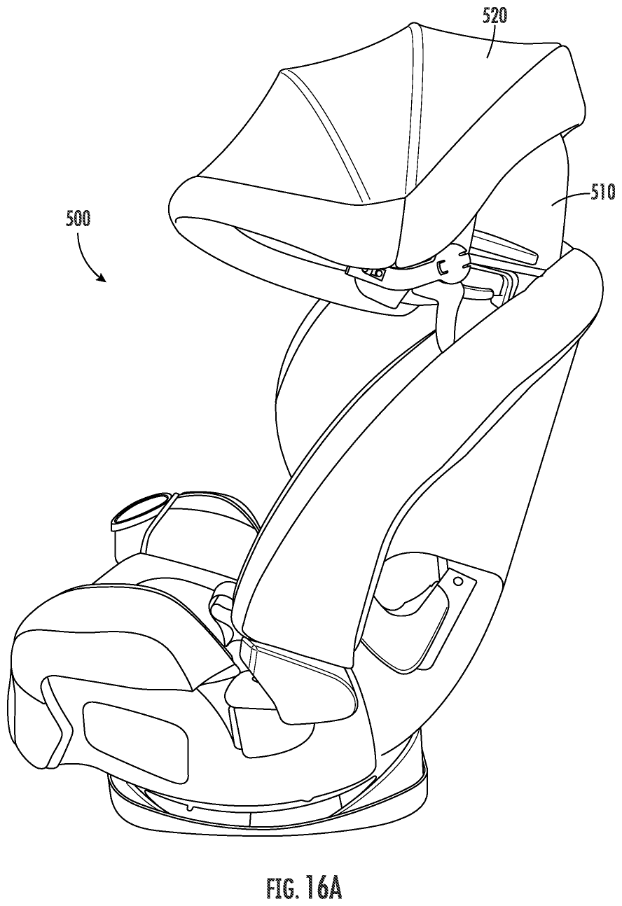

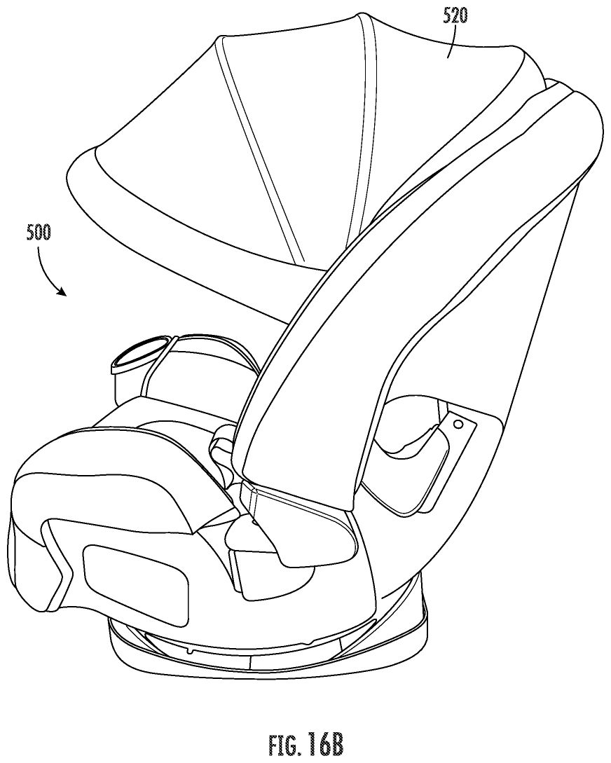

FIG. 2 shows the hard goods 12 of the car seat 10. The soft goods 14 of the car seat 10 are not shown in FIG. 2 for clarity. The hard goods 12 preferably include a seat frame 20 and headrest 30. The seat frame 20 provides the support for the soft goods 14 of the car seat 10 shown in FIGS. 1A and 1B. The seat frame 20 preferably includes a first sidewall 22 and a second sidewall 24. The first and second sidewalls 22, 24 have a front end 21 and rear end 23. The soft goods 14 (shown in FIGS. 1A, 1B) wrap around the first sidewall 22 and second sidewall 24. The headrest 30 is attached to the seat frame 20 to support a child's head while in the car seat 10. The headrest 30 can be adjustably attached to the frame 20 to move up and down between a raised position (FIG. 16A), a lowered position (FIG. 16B), and one or more intervening positions to adjust for a growing child.

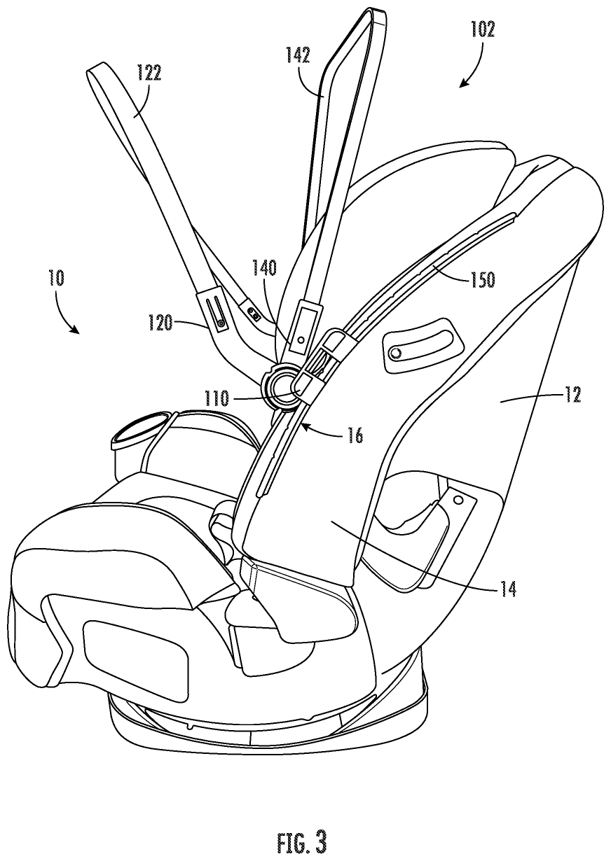

FIG. 3 shows the car seat 10, including the car seat hard goods 12 and soft goods 14, and the hard goods 102 of the car seat canopy assembly 100. The canopy 104 is not shown for clarity. The hard goods 102 of the car seat canopy assembly 100 preferably include a canopy mount 110, a first canopy bow connector 120, a first canopy bow 122, a second canopy bow connector 140, and a second canopy bow 142. The first canopy bow connector 120 and the second canopy bow connector 140 can have similar or different shapes. In an embodiment, the hard goods 102 of the car seat canopy assembly 100 can also include the canopy track 150. As shown in FIG. 3, the canopy track 150 may protrude above the soft goods 14 along the front end 21 of sidewalls 22, 24. For example, the canopy track 150 can be an injection molded piece that can be attached to the soft goods 14. For example and without limitation, the canopy track 150 can be sewn to a seam of the soft goods 14. In another example, the canopy track can be formed with or attached to sidewalls 22, 24 and protrude through an opening 16 in the soft goods 14 of the car seat 10. Although not visible in FIG. 3, the opposing side of the car seat 10 includes a third canopy bow connector, a fourth canopy bow connector, a second canopy mount, and a second canopy track which are mirror images of the first canopy bow connector 120, second canopy bow connector 140, canopy mount 110, and canopy track 150. The first canopy bow 122 may removably connect to the first canopy bow connector 120 and the third canopy bow connector. The second canopy bow 142 may removably connect to the second canopy bow connector 140 and the fourth canopy bow connector. Alternatively, the canopy bow connectors 120, 140 and the canopy bow 122, 142 may form one unified piece. The canopy 104, shown in FIGS. 1A and 1B, connects to the canopy bows 122, 142.

FIG. 4 shows the car seat hard goods 12, the canopy track 150, the canopy mount 110, the first canopy bow connector 120, and a second canopy bow connector 140. The soft goods 14 of the car seat 10 are not shown for clarity. As shown in FIG. 4, the canopy track 150 is positioned towards the front end 21 of the sidewall 22. The front or front end 14, as referred to on the car seat 10, means the direction the child is facing while sitting in the car seat 10. Providing the canopy track 150 along the front end 21 or positioned towards the front end 21 of the sidewall 22 provides ease of access to the user repositioning the canopy 104, preserves the canopy's 104 shape, and prevents the canopy 104 from bowing out at the sides. The sidewall 22 may also include a level indicator 25 to show whether the car seat 10 is properly installed in the vehicle.

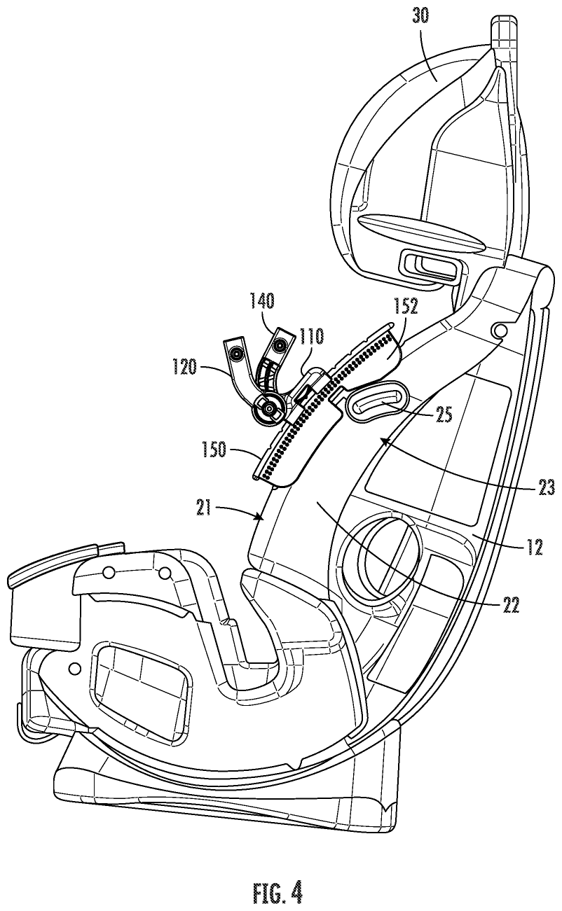

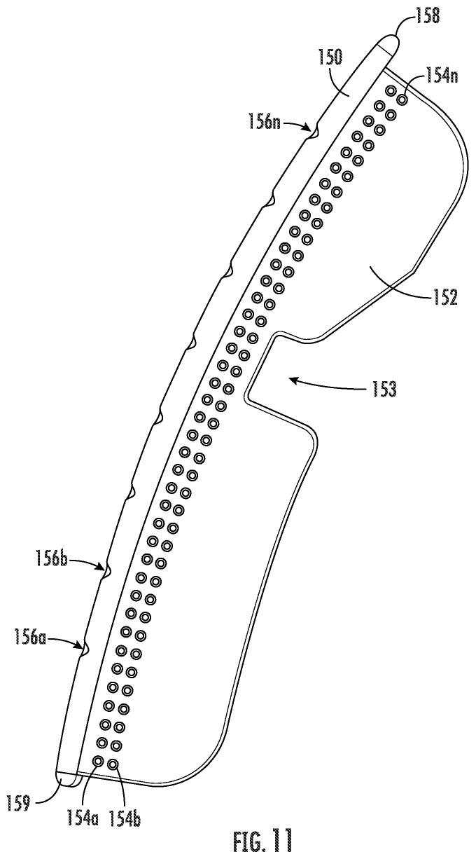

FIG. 5 shows the canopy track 150, the canopy mount 110, the first canopy bow connector 120, and the second canopy bow connector 140. As shown in FIG. 5, the canopy bow connectors 120, 140 are connected to the canopy mount 110. The canopy mount 110 is slidably connected to the canopy track 150. The canopy mount 110 can manually move up and down along the canopy track 150. The canopy track 150 may include a flat plate 152. The plate 152 abuts the sidewall 22 as shown in FIG. 4. As shown in FIGS. 5 and 11, the plate 152 may include a plurality of apertures 154a-n that allow the plate 152 to be sewn to the soft goods 14 of the car seat 10. Alternatively, the plate 152 may be configured to be sewn to the soft goods 14 without apertures 154a-n. For example, and without limitation, the plate 152 may be thin enough to allow a sewing machine to penetrate the plate 152 so that the plate 152 may be sewn to the soft goods 14. Alternatively, the plate 152 may be directly fastened to the sidewalls 22, 24.

The track 150 preferably includes a plurality of position detents 156a-n. The position detents 156a-n are configured to receive a protrusion 114 on a passive flex beam 112 on the canopy mount 110. As the canopy mount 110 is manually moved up and down along the track 150, the protrusion 114 catches a position detent 156a-n. The protrusion 114 supports the canopy mount 110 at a user selected position when nested in a position detent 156a-n. A user may change the position of the car seat canopy assembly 100 up and down the track 150 by force. When the user applies force to the canopy mount 110, the passive flex beam 112 will flex to allow the protrusion 114 to travel between position detents 156a-n.

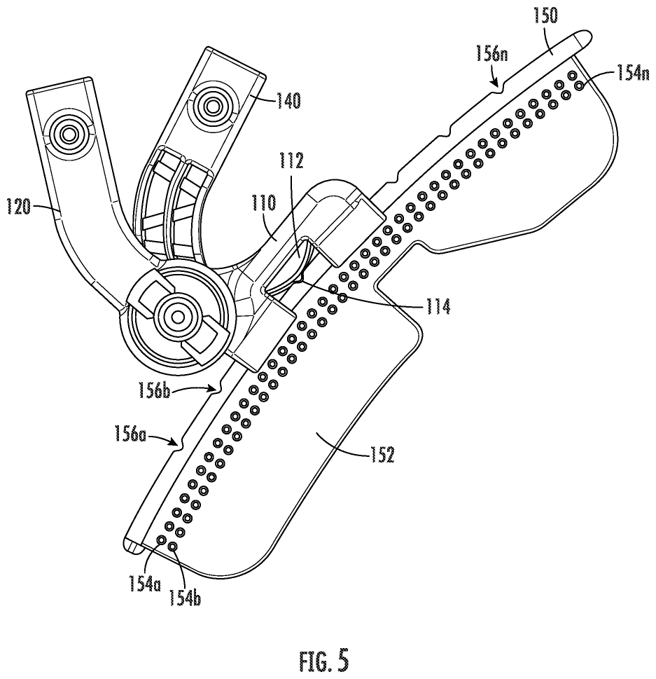

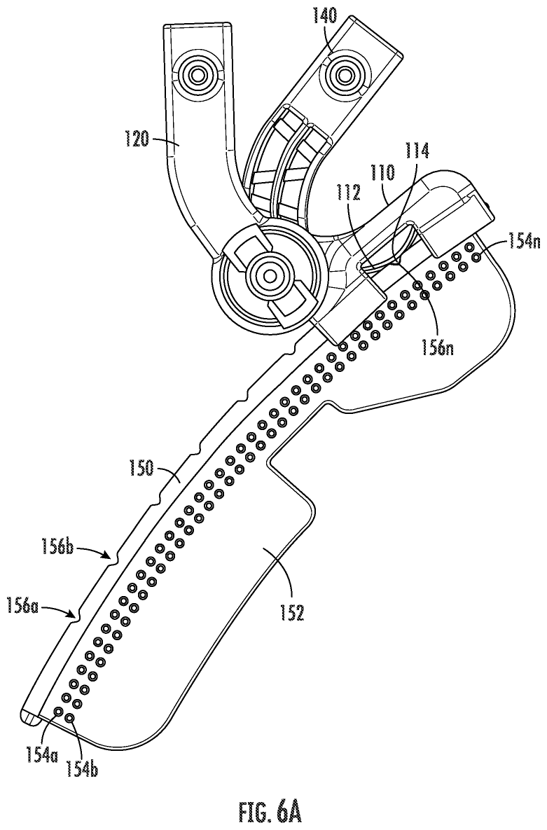

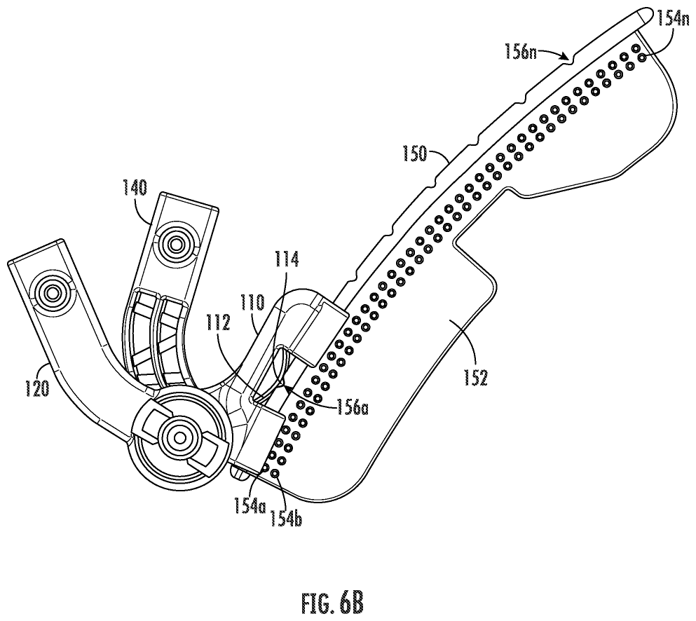

FIGS. 6A and 6B show the canopy mount 110 at different positions along the canopy track 150. FIG. 6A shows the canopy mount 110 at a raised position. FIG. 6B shows the canopy mount 110 at a lowered position. These raised and lowered positions correspond to the positions in FIGS. 1A and 1B respectively. The canopy mount 110 may be positioned at any of the position detents 156a-n along the track 150. There may be any number of position detents 156a-n along the track 150 to provide the user a variety of positioning options to optimize the shade on the child in the car seat 10.

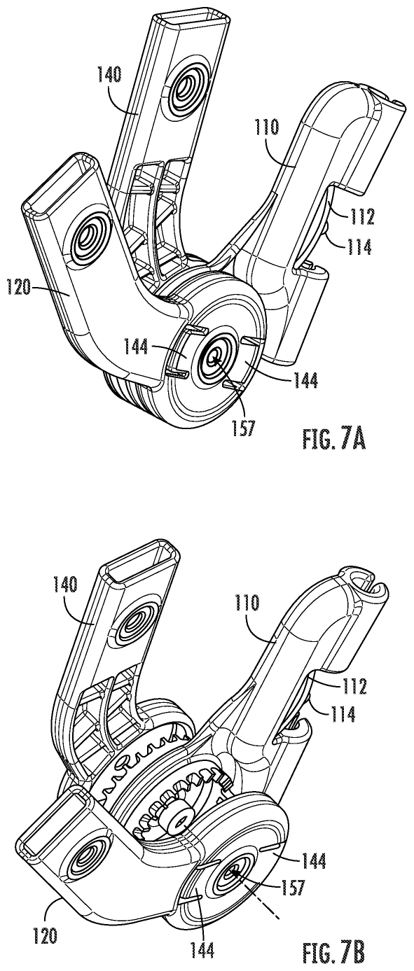

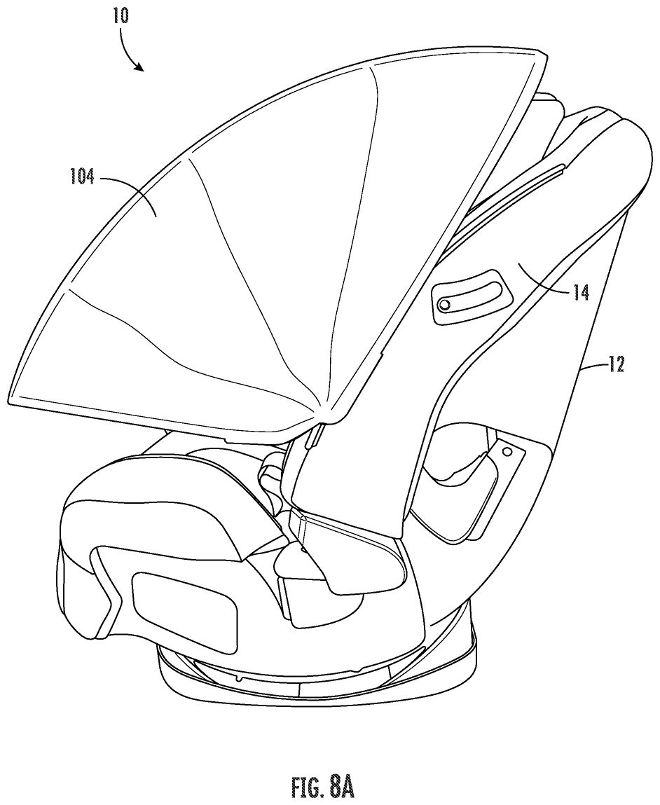

FIGS. 7A and 7B show the canopy mount 110 and first and second canopy bow connectors 120, 140. The canopy bow connectors 120, 140 preferably connect to opposite sides of the canopy mount 110. The canopy bow connectors 120, 140 and the canopy mount 110 may be connected together via a fastener extending through a commonly aligned center opening 157 of the canopy bow connectors 120, 140 and the canopy mount 110. The canopy bow connectors 120, 140 can rotate relative to the canopy mount 110 to various positions, including a cocooned position where the canopy is extended to shade the child, as shown in FIG. 8A, and a stored position where the canopy is rotated back into the seat, as shown in FIG. 8B.

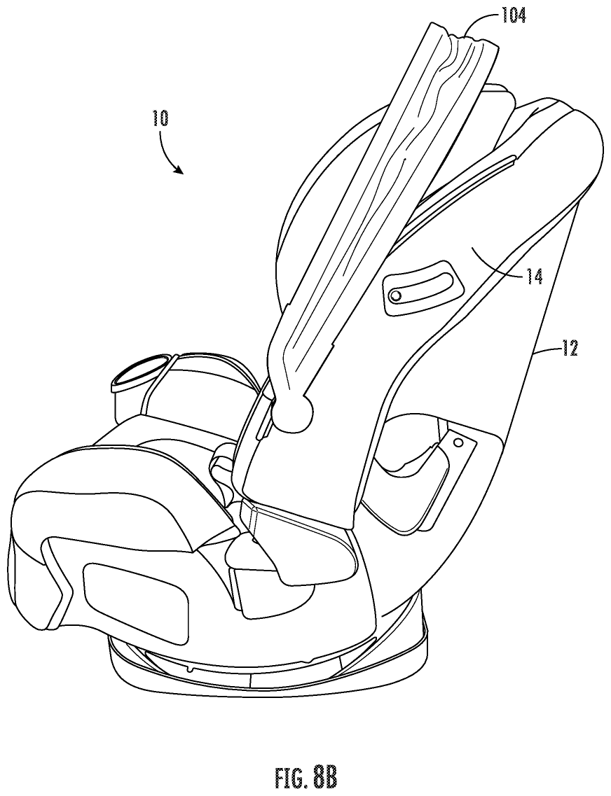

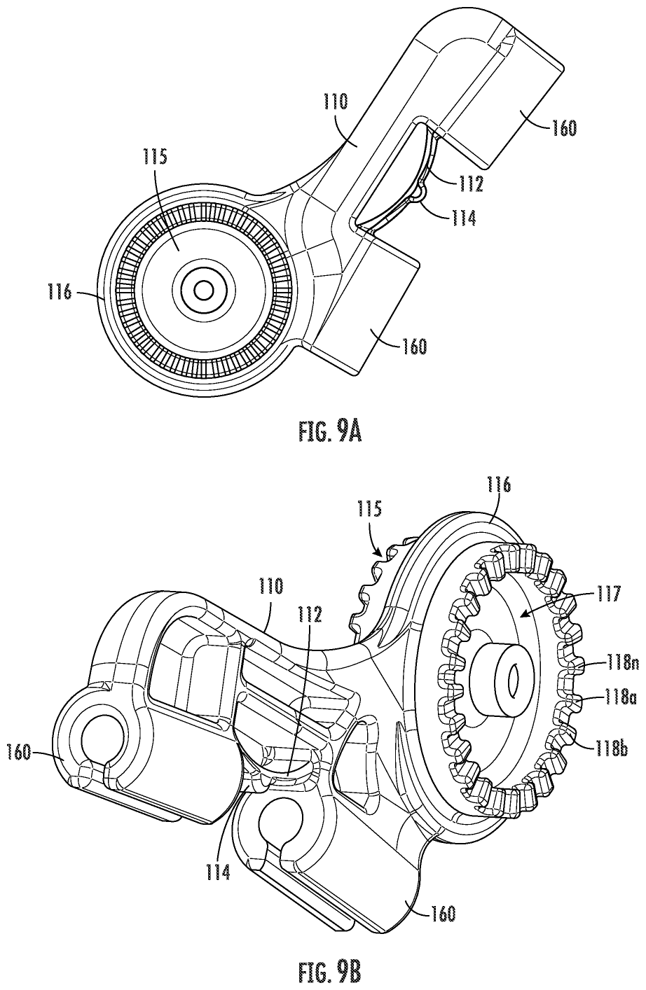

FIGS. 9A and 9B show the canopy mount 110. The canopy mount 110 includes a stud 116 having inner and outer sides 115, 117. The stud is preferably circular shaped. The stud 116 preferably includes ratcheting teeth 118a-n aligned along the perimeter of the stud 116 on one or both of the inner and outer sides 115, 117. The ratcheting teeth 118a-n are configured to engage with the canopy bow connectors 120, 140 and cooperate with the canopy bow connectors 120, 140 to rotate the canopy 104. The ratcheting teeth 118a-n may extend the entire perimeter of the stud 116, as shown in FIGS. 9A and 9B, or the ratcheting teeth 116a-n may extend along only a portion of the perimeter of the stud 116.

FIGS. 9A and 9B also show the passive flex beam 112 and the protrusion 114 that interacts with the position detents 156a-n on the canopy track 150. The canopy mount 110 also preferably has at least one channel 160 configured to receive and retain the canopy track 150 as shown in FIGS. 6A and 6B, and slide along the canopy track 150. For example and without limitation, the channel 160 is preferably a C-shaped channel as shown in FIGS. 9A and 9B.

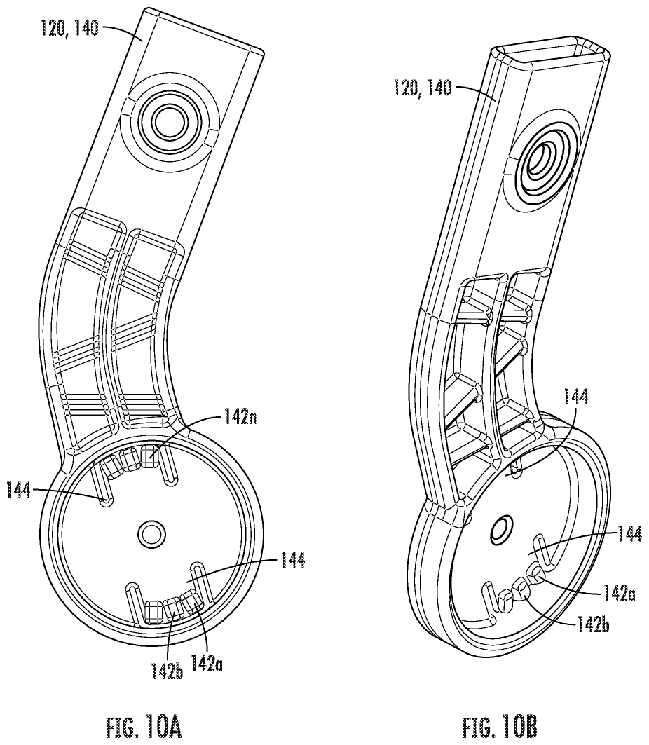

FIGS. 10A and 10B show the canopy bow connectors 120, 140. The canopy bow connectors 120, 140 preferably include a plurality of prongs 142a-n located on clips 144 that are configured to flex. The prongs 142a-n interact with the ratcheting teeth 118a-n on the canopy mount stud 116 shown in FIGS. 8A and 8B. When force is applied to rotate the connector 120, 140 about the canopy mount stud 116, the clips 144 flex and the prongs 142a-n interact with the ratcheting teeth 118a-n to allow the connectors 120, 140 to rotate to different angles. The prong 142a-n and teeth 118a-n connection allows the canopy 104 to rotate to different positions, such as between the cocooned position and the stored position shown in FIGS. 8A and 8B respectively.

FIG. 11 shows the canopy track 150. The canopy track 150 may be formed via injection molding. As shown in FIG. 11, the plate 152 of the canopy track 150 may have a shape or have cutouts 153 to accommodate other car seat 10 components, such as the level indicator 25 shown in FIG. 4. The canopy track 150 may include an open end 158 that allows the canopy mount 110 to slide off the track 150. The open end 158 may be positioned at the upper end of the track 150. The open end 158 allows a user to remove the canopy 104 from the car seat 10. The canopy track 150 may also include a closed end 159. The closed end 159 may be positioned at the lower end of the track 150. The closed end 159 prevents the canopy mount 110 from sliding off the canopy track 150. As previously stated, the canopy track 150 protrudes through the soft goods 14 of the car seat 10 as shown in FIG. 3.

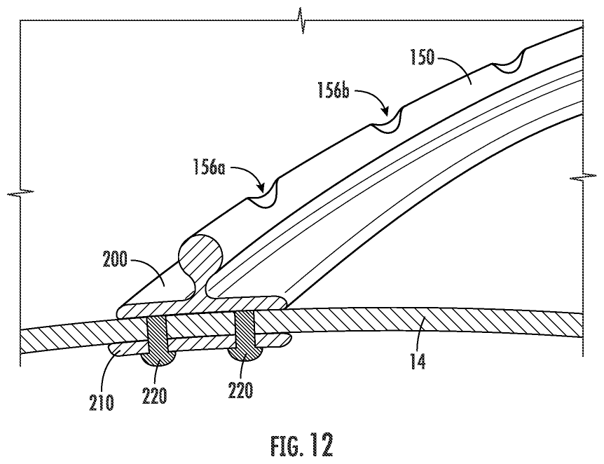

FIG. 12 shows an alternative method of attaching the canopy track 150 to the soft goods 14 of the car seat 10. FIG. 12 shows a section of soft goods 14 that would cover a sidewall 22, 24. In this embodiment, the canopy track 150 is connected to a top plate 200. The top plate 200 is attached to a back plate 210. The top plate 200 and the back plate 210 sandwich the soft goods 14. The top plate 200 is connected to the bottom plate 210 via fasteners 220, such as rivets or screws, that extend through the soft goods 14. The bottom plate 210 may extend the length of the canopy track 150 and top plate 200. Alternatively, there may be a plurality of bottom plates 210 separated and attached along the top plate 200.

One of skill in the art will recognize that the canopy track 150 may be connected to the soft goods 14 by others means. For example, the soft goods 14 may include a plurality of magnets that connect to corresponding magnets in the canopy track 150 or top plate 200.

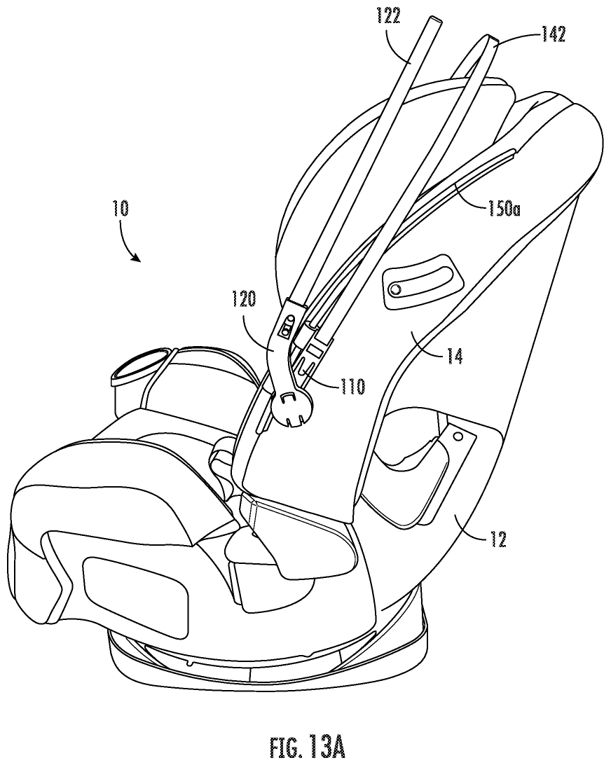

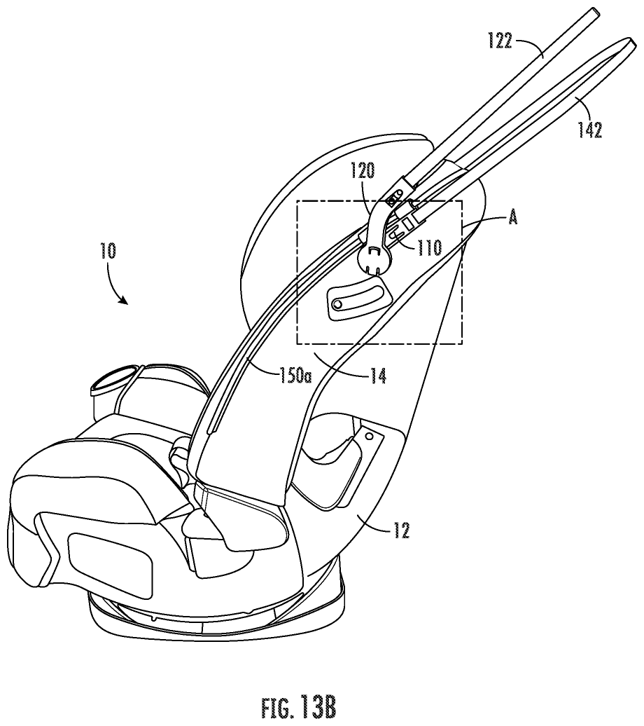

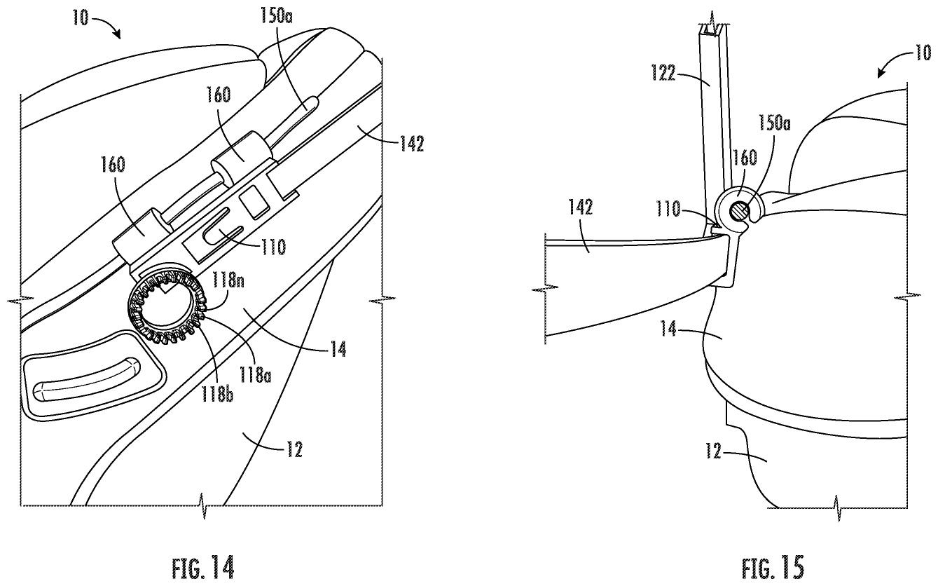

FIGS. 13A and 13B show a car seat 10 with a car seat canopy assembly 100 without the canopy 104. FIGS. 13A, 13B, 14, and 15 show another embodiment of a car seat canopy assembly 100 in which the canopy track 150a is a piping in the soft goods 14. FIG. 13A shows the canopy mount 110 in a lowered position on the canopy track 150a. FIG. 13B shows the canopy mount 110 in a raised position on the canopy track 150a. FIG. 14 shows a magnified view of a portion of the car seat 10 and the canopy assembly 100 depicted by section A in FIG. 13B with the first canopy bow connector 120 removed. FIG. 15 shows a cross section view of the soft goods piping that functions as the canopy track 150a.

According to the exemplary embodiment shown in FIGS. 13A, 13B, 14, and 15, the canopy track 150a is formed by the piping of the soft goods 14 of the car seat 10. The channel 160 of the canopy mount 110 is configured to receive and manually slide along the canopy track 150a. The channel 160 and canopy track 150a have a friction fit. A user applying reasonable force to the canopy mount 110 can overcome the friction to move the canopy mount 110 up and down along the canopy track 150a to various positions along the track 150a. When force is no longer applied to the canopy mount 110, the friction between the channels 160 and the canopy track 150a maintain the canopy mount 110 in position. The canopy mount 110 can be detached from the canopy track 150a by sliding the channel 160 off of the soft goods piping at one end for easy removal and assembly.

FIGS. 16A and 16B show a car seat 500 with a height adjustable headrest 510. The height adjustable headrest 510 includes a canopy 520. FIG. 15A shows the headrest 510 in a raised position. FIG. 15B shows the headrest 510 in a lowered position. The headrest 510 is height adjustable from a lowered position to a raised position to accommodate a growing child. The headrest 510 is height adjustable according to means and methods known in the art, including, without limitation, those disclosed in U.S. Pat. Nos. 8,087,725 and 7,232,185, both of which are incorporated by reference as if fully set forth herein. The canopy 520 provides shade to the child in the car seat 500. The canopy 520 changes height position along with the headrest 510 thereby providing shade to the child in the car seat 500 as the child grows.

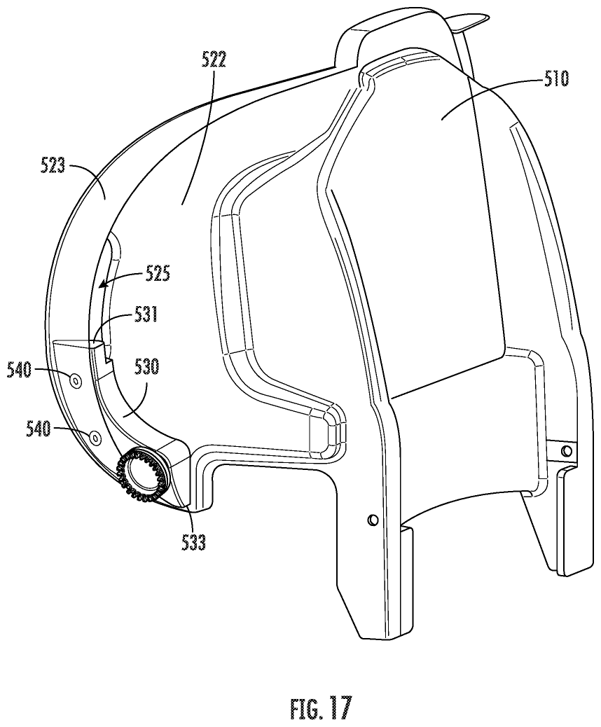

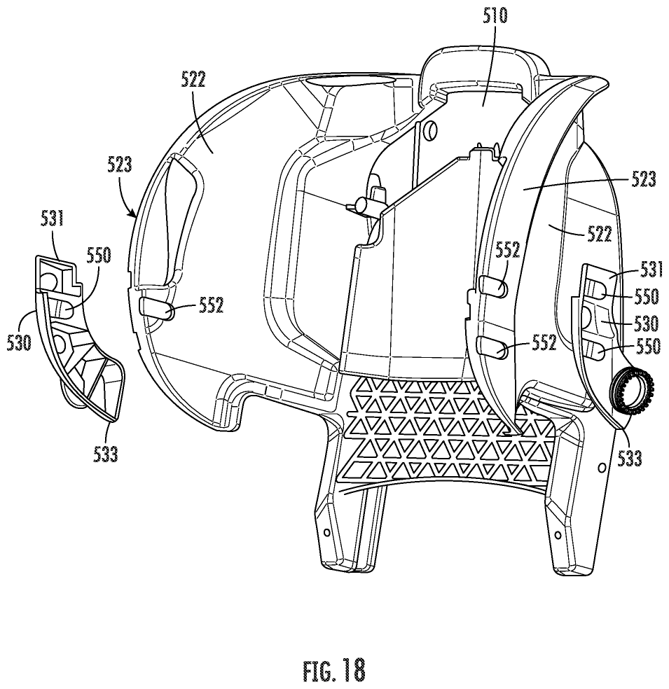

FIGS. 17 and 18 show the headrest 510 with the canopy 520 removed from the car seat 500 for ease of reference. The headrest 510 includes canopy mounts 530 connected to the headrest 510. The canopy 520 shown in FIGS. 16A and 16B connects to the canopy mounts 530. The canopy mounts 530 may be connected to the headrest 510 in various ways. For example, the canopy mounts 530 may be connected to the headrest 510 via fasteners 540 as shown in FIG. 17. Alternatively, the canopy mounts 530 may be connected to the headrest 510 via clips 550 as shown in FIG. 18. The clips 550 clip into corresponding openings 552 in the headrest 510. Each clip 550 may comprise a spring finger that is biased into a corresponding opening 552 when the canopy mount 530 is coupled to the headrest 510. Alternatively, the canopy mounts 530 may be molded into the headrest 510 so that the headrest 510 and the canopy mounts 530 form one piece. The headrest 510 includes sidewalls 522 that have an edge 523 formed to receive at least a portion of the canopy mounts 530. As shown in FIG. 17, the back side of the edge 523 and the sidewall 522 form a recess 525 that is open towards the rear of the car seat 500. The recess 525 is configured to receive and support the canopy mount 530. The canopy mounts 530 include a first end 531 that nests in the recess 525 formed by the edge 523 and the sidewall 522 and a second end 533 that extends beyond the edge 523.

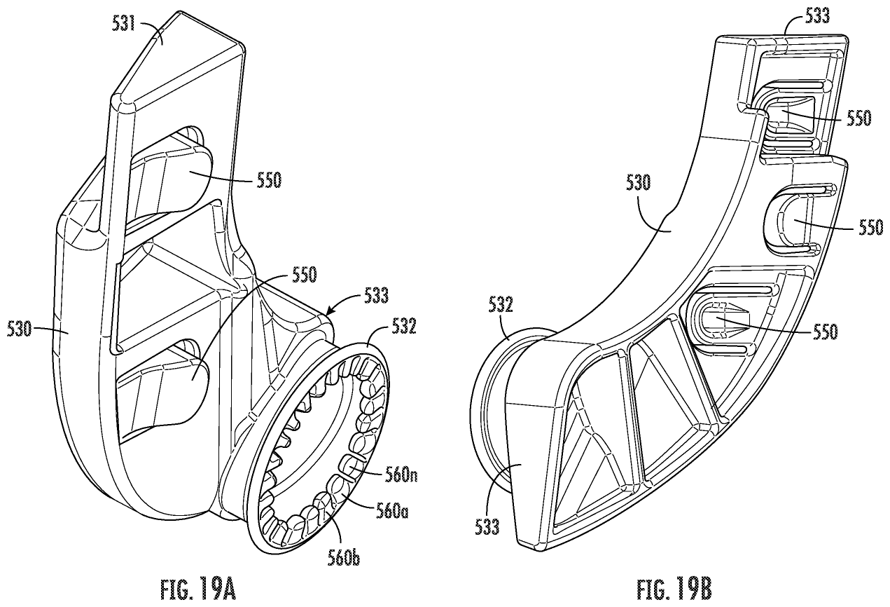

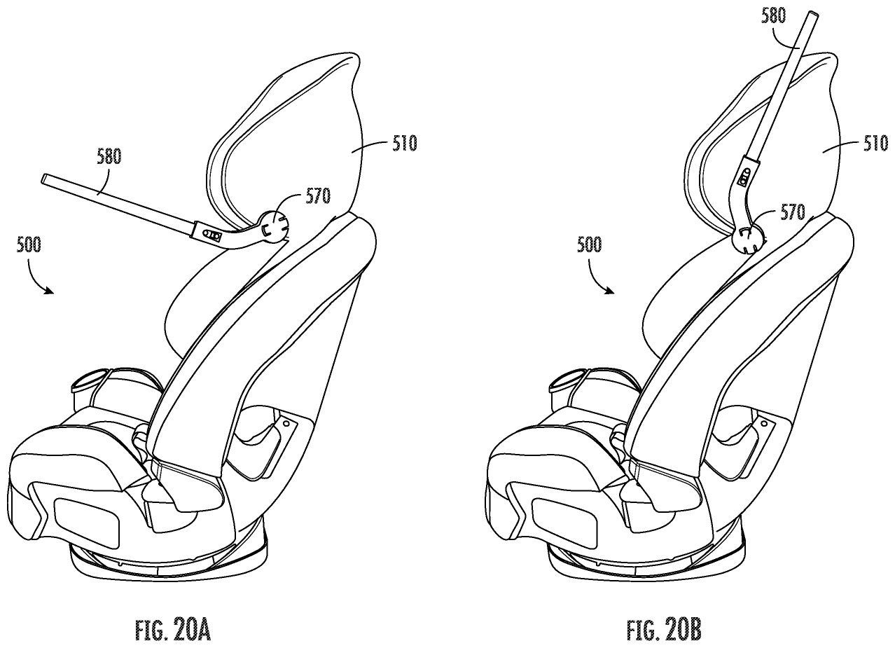

FIGS. 19A and 19B show the canopy mounts 530. The canopy mounts 530 shown in FIGS. 19A and 19B include clips 550. However, the canopy mounts 530 may alternatively include apertures to receive mechanical fasteners to connect to the headrest 510, or the canopy mounts 530 may be molded in the headrest 510 as described above. The canopy mounts 530 are shaped to correspond to the shape of the headrest 510. The first ends 531 of the canopy mounts 530 are shaped to nest in the edge 523 of the sidewall 522 shown in FIGS. 17 and 18. The first end 531 can be coupled to the headrest 510 within the recess 525. The second ends 533 of the canopy mounts 530 preferably include studs 532. The studs 532 protrude from the headrest 510. Canopy bow connectors 570 shown in FIGS. 20A and 20B connect to the studs 532. The studs 532 include ratcheting teeth 560a-n. The ratcheting teeth 560a-n perform the same functions and serve the same purpose as the ratcheting teeth 118a-n on the canopy mount 110 in FIG. 9B.

FIGS. 20A and 20B show the canopy bow connector 570 attached to the canopy mount stud 532. The canopy bow connector 570 includes the details and embodiments of the canopy bow connectors 120, 140 shown in FIGS. 10A and 10B. The connector 570 rotates about the stud 532 so that a canopy bow 580 rotates between a cocooning position, as shown in FIG. 20A, and a stored position, as shown in FIG. 20B. Although only one canopy bow 580 is shown, one of skill in the art would understand that the headrest 510 can include more than one canopy bow with corresponding connectors. For example and without limitation, the headrest 510 may include two canopy bows configured similarly to the first and second canopy bows 122, 142 previously described and shown in at least FIG. 3. The canopy 520 shown in FIGS. 16A and 16B connects to the canopy bow 580. The canopy 520 may also connect to the back of the headrest 510.

A user can connect a first canopy bow connector 570 to a first canopy mount 530 on a headrest 510. The user can also connect a second canopy bow connector 570 to a second canopy mount 530 on the headrest 510. A canopy bow 580 connects to the first and second canopy bow connectors 570. A canopy 520 connects to the canopy bow 580. The user can also connect the canopy 520 to the back of the headrest 510.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

1. A car seat canopy assembly comprising:
at least one track that protrudes from a soft goods of a car seat along a sidewall of the car seat;
at least one canopy mount slidably connected to the at least one track such that the canopy mount can translate along the at least one track; and
a canopy connected to the at least one canopy mount.

2. The car seat canopy assembly according to claim 1, wherein
the at least one track comprises left and right tracks respectively positioned along left and right sidewalls of the car seat;
the at least one canopy mount comprises left and right canopy mounts connected to the left and right tracks respectively; and
the canopy is connected to the left and right canopy mounts.

3. The car seat canopy assembly according to claim 1, wherein the at least one track is positioned along a front end of the sidewall of the car seat.

4. The car seat canopy assembly according to claim 1, wherein the at least one track is a part of or attached to the soft goods of the car seat.

5. The car seat canopy assembly according to claim 1, wherein the at least one track that is molded with or secured to the frame of the car seat, the soft goods define a slot from which the track can protrude.

6. The car seat canopy assembly according to claim 1, wherein the at least one track is a piping of the soft goods.

7. The car seat canopy assembly according to claim 1, wherein the at least one track is sewn to the soft goods.

8. The car seat canopy assembly according to claim 1, wherein the at least one track is fastened to the soft goods.

9. The car seat canopy assembly according to claim 1, wherein the at least one track is a part of a top plate, the top plate is attached to a bottom plate via a plurality of fasteners extending through the soft goods.

10. The car seat canopy assembly according to claim 1, wherein the at least one track is a separate molded part.

11. The car seat canopy assembly according to claim 1, wherein each track has a flat plate that abuts a sidewall of the car seat.

12. The car seat canopy assembly according to claim 1, wherein the at least one track includes detent positions that provide predetermined positioning locations of the at least one canopy mount.

13. The car seat canopy assembly according to claim 12, wherein the at least one canopy mount includes a passive flux beam to position the canopy mount at a selected detent position along the at least one track.

14. The car seat canopy assembly according to claim 1, wherein the at least one canopy mount includes a C-channel configured to receive the at least one track.

15. The car seat canopy assembly according to claim 1, wherein the at least one track includes a first unobstructed end and a second end including a stop.

16. The car seat canopy assembly according to claim 1, wherein the canopy mount includes a stud including a plurality of ratcheting teeth that allow the canopy to rotate to various positions between a cocooning position and a stored position.

17. A car seat comprising:
soft goods;
at least one canopy track attached to the soft goods; and
a canopy mount movably connected to the at least one canopy track to adjust a height position of a canopy attached to the canopy mount;
wherein removal of the soft goods from the car seat results in removal of the canopy track.

18. The car seat according to claim 17, wherein the at least one track is sewn to the soft goods.

19. The car seat according to claim 17, wherein the at least on track is fastened to the soft goods.

20. The car seat according to claim 17, wherein the at least one track is a part of a top plate, the top plate is attached to a bottom plate via a plurality of fasteners extending through the soft goods.

21. The car seat according to claim 17, wherein the at least one track is a separate molded part.

22. The car seat according to claim 17, wherein the at least one track includes detent positions that provide predetermined positioning locations of the at least one canopy mount.

23. The car seat according to claim 22, wherein the at least one canopy mount includes a passive flux beam to position the canopy mount at a selected detent position along the at least one track.

24. The car seat according to claim 17, wherein the at least one canopy mount includes a C-channel configured to receive the at least one track.

25. The car seat according to claim 17, wherein the at least one track includes a first unobstructed end and a second end including a stop.

26. The car seat according to claim 17, wherein the at least one track is positioned at a front end of a sidewall of the car seat.

27. The car seat according to claim 17, wherein the canopy mount includes a stud including a plurality of ratcheting teeth that allow the canopy to rotate to various positions between a cocooning position and a stored position.

28. A car seat comprising:
soft goods including at least one canopy track; and
a canopy including at least one canopy mount removably attached to the at least one canopy track, the canopy mount configured to slide along the at least one canopy track.

29. The car seat according to claim 28, wherein the at least one track is a piping of the soft goods.

30. The car seat according to claim 28, wherein the at least one canopy mount includes a C-channel configured to receive the at least one track.

31. The car seat according to claim 28, wherein the at least one track includes a first unobstructed end and a second end including a stop.

32. The car seat according to claim 28, wherein the canopy mount includes a stud including a plurality of ratcheting teeth that allow the canopy to rotate to various positions between a cocooning position and a stored position.

33. A method of adjusting a car seat canopy assembly comprising:
providing a car seat with soft goods;
providing a canopy assembly for the car seat comprising:
at least one track that protrudes from the soft goods of the car seat along a front portion of a sidewall of the car seat;
at least one canopy mount slidably connected to the at least one track; and
a canopy connected to the at least one canopy mount;
translating the canopy assembly along the track between a lower position and an upper position.

34. The method of claim 33, wherein
the canopy mount further comprises a stud including a plurality of ratcheting teeth that allow; and
the method further comprises moving the canopy along the ratcheting teeth of the stud of the canopy mount to rotate to the canopy to various positions between a cocooning position and a stored position.

35-48. (canceled)
